(19) United States
(12) Patent Application Publication
(10) Pub. No.: US 2024/0357593 A1
(43) Pub. Date: Oct. 24, 2024

(54) METHOD AND APPARATUS FOR DETERMINING PROCESSING TIME, UE, AND STORAGE MEDIUM

(71) Applicant: VIVO MOBILE COMMUNICATION CO., LTD., Dongguan (CN)

(72) Inventors: Lihui WANG, Dongguan (CN); Xueming PAN, Dongguan (CN)

(73) Assignee: VIVO MOBILE COMMUNICATION CO., LTD., Dongguan (CN)

(21) Appl. No.: 18/759,803

(22) Filed: Jun. 28, 2024

Related U.S. Application Data
(63) Continuation of application No. PCT/CN2022/141547, filed on Dec. 23, 2022.

(30) Foreign Application Priority Data
Dec. 29, 2021 (CN) 202111643902.3

(51) Int. Cl. H04W 72/1273; H04L 1/1812; H04W 72/232; H04W 72/51

(52) U.S. Cl. CPC H04W 72/1273; H04L 1/1812; H04W 72/232; H04W 72/51

(57) ABSTRACT

This application provides a method and an apparatus for determining a processing time, UE, and a storage medium. The method for determining a processing time includes: when UE has been configured with or has enabled a relaxed processing capability, determining, based on the relaxed processing capability, a target time related to communication, where the relaxed processing capability is a processing capability that is relaxed in time.

### CROSS-REFERENCE TO RELATED APPLICATIONS

This application is a continuation of International Application No. PCT/CN2022/141547, filed on Dec. 23, 2022, which claims priority to Chinese Patent Application No. 202111643902.3 filed in China on Dec. 29, 2021. The entire contents of each of the above-referenced applications are expressly incorporated herein by reference.

### TECHNICAL FIELD

This application pertains to the field of communications technologies, and in particular, to a method and an apparatus for determining a processing time, UE, and a storage medium.

### BACKGROUND

The processing time of User Equipment (UE) in the communications system is usually determined based on a processing capability of the UE. At present, the UE processing capability defined in the communications system mainly includes a UE processing capability 1 (UE processing capability 1), and the UE determines a target time related to communication mainly based on the UE processing capability 1. Generally, the time determined based on the UE processing capacity 1 is short, and such a short time may lead to poor communications performance of the UE.

### SUMMARY

Embodiments of this application provide a method and an apparatus for determining a processing time, UE, and a storage medium.

According to a first aspect, a method for determining a processing time is provided, and the method includes:
in a case that UE has been configured with or has enabled a relaxed processing capability, determining, based on the relaxed processing capability, a target time related to communication, where the relaxed processing capability refers to a processing capability that is relaxed in time.

According to a second aspect, an apparatus for determining a processing time is provided, and the apparatus includes:
a determining module, configured to: in a case that UE has been configured with or has enabled a relaxed processing capability, determine, based on the relaxed processing capability, a target time related to communication, where the relaxed processing capability refers to a processing capability that is relaxed in time.

According to a third aspect, UE is provided. The UE includes a processor and a memory, where the memory stores a program or an instruction that can be run on the processor, and the program or the instruction is executed by the processor to implement steps of the method for determining a processing time according to the embodiments of this application.

According to a fourth aspect, a terminal is provided, including a processor and a communications interface, where the processor or the communications interface is configured to: in a case that UE has been configured with or has enabled a relaxed processing capability, determine, based on the relaxed processing capability, a target time related to communication, where the relaxed processing capability refers to a processing capability that is relaxed in time.

According to a fifth aspect, a readable storage medium is provided, where the readable storage medium stores a program or an instruction, and when the program or the instruction is executed by a processor, steps of the method for determining a processing time provided in the embodiments of this application are implemented.

According to a sixth aspect, a chip is provided. The chip includes a processor and a communications interface, where the communications interface is coupled to the processor, and the processor is configured to run a program or an instruction to implement steps of the method for determining a processing time provided in the embodiments of this application.

According to a seventh aspect, an embodiment of this application provides a computer program product. The computer program product is stored in a storage medium, and the computer program product is executed by at least one processor to implement steps of the method for determining a processing time provided in the embodiments of this application.

According to an eighth aspect, a communications device is provided, configured to perform steps of the method for determining a processing time provided in the embodiments of this application.

In the embodiments of this application, in a case that UE has been configured with or has enabled a relaxed processing capability, a target time related to communication is determined based on the relaxed processing capability, where the relaxed processing capability refers to a processing capability that is relaxed in time. In this way, the target time related to communication is determined based on the relaxed processing capability, and thus the communication-related time of the UE can be relaxed, to improve the communications performance of the UE.

### BRIEF DESCRIPTION OF DRAWINGS

FIG. 1 is a block diagram of a wireless communication system for performing the embodiments of this application;

FIG. 2 is a flowchart of a method for determining a processing time according to an embodiment of this application;

FIG. 3 is a structural diagram of an apparatus for determining a processing time according to an embodiment of this application;

FIG. 4 is a structural diagram of a communications device according to an embodiment of this application; and

FIG. 5 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th generation (6th Generation, 6G) communications system.

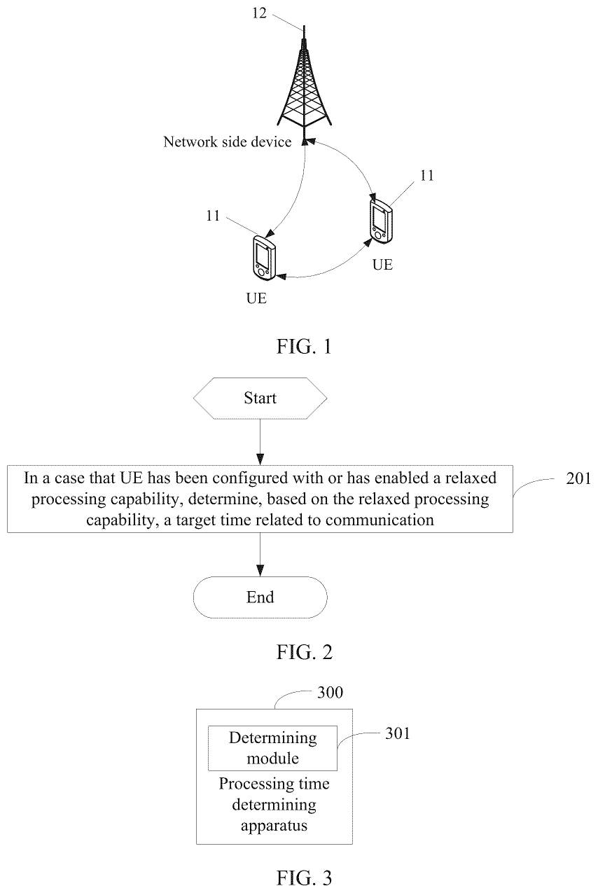

FIG. 1 is a block diagram of a wireless communication system to which the embodiments of this application can be applied. The wireless communication system includes a terminal 11 and a network side device 12.

In the embodiments of this application, the terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal is not limited in the embodiments of this application.

The network side device 12 may include an access network device or a core network device. The access network device may also be referred to as a radio access network device, a Radio Access Network (RAN), a RAN function, or a RAN unit. The access network device may include a base station, a Wireless Local Area Network (WLAN) access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), and an Application Function (AF). It should be noted that, in the embodiments of this application, only a core network device in an NR system is used as an example for description, and a specific type of the core network device is not limited.

The following describes in detail the method and apparatus for determining a processing time, a terminal, and a storage medium provided in the embodiments of this application through some embodiments and application scenarios thereof with reference to the accompanying drawings.

Referring to FIG. 2, FIG. 2 is a flowchart of a method for determining a processing time according to an embodiment of this application. As shown in FIG. 2, the method includes the following steps.

Step 201. In a case that UE has been configured with or has enabled a relaxed processing capability, determine, based on the relaxed processing capability, a target time related to communication, where the relaxed processing capability refers to a processing capability that is relaxed in time.

The relaxed processing capacity may be a processing capacity defined in the protocol, and the relaxed processing capacity may be a processing capacity to further relax (also referred to as loose) the UE processing time on the basis of the processing capacity defined in the protocol.

In some implementations, the relaxed processing capability can be referred to as a UE processing capability 3 (UE processing capability 3), and a processing time of the processing capability is longer than that of a UE processing capability 1 (UE processing capability 1) defined in the protocol. Further, the processing time of the relaxed processing capability can also be longer than that of a UE processing capability 2 (UE processing capability 2) defined in the protocol.

It should be noted that in this embodiment of this application, the relaxed processing capability can also be referred to as a relaxed processing time capability.

The UE may be UE with a reduced capacity (RedCap UE) or common UE.

In this embodiment of this application, the target time related to communication may be a transmission time, a time interval, a switch time, a UE expected time, or the like.

The determining, based on the relaxed processing capacity, the target time related to communication can be understood as relaxing the target time related to communication based on the relaxed processing capacity. For example, the UE may perform corresponding communications operations based on the target time. For example, performing communications operations such as uplink transmission, downlink transmission, and switching.

In this embodiment of this application, the target time related to communication can be determined based on the relaxed processing capacity through the above steps, and the communication-related time of the UE can be relaxed, thus allowing the UE to complete a corresponding communications operation in a longer time, so as to improve the communications performance of the UE. Further, because the communication-related time of the UE is relaxed, the complexity and cost requirements for the UE are lower, thereby achieving the effect of reducing the complexity and cost of the UE.

In some implementations, the target time related to communication includes at least one of the following:
a transmission time interval, a transmission timing adjustment time, a switch time, an uplink transmission time, a downlink transmission time, and an expected transmission time.

The transmission time interval may be a time interval between downlink reception and uplink transmission, for example, a transmission time interval between a Physical Downlink Control Channel (PDCCH) and a Physical Random Access Channel (PRACH), or a transmission time interval between a Physical Downlink Shared Channel (PDSCH) and the PRACH, or a transmission time interval between the PDSCH and a Physical Uplink Shared Channel (PUSCH).

The transmission timing adjustment time may be a time for adjusting uplink transmission timing or a time for adjusting downlink transmission timing.

The switch time may be a time for performing communication-related switching.

The uplink transmission time may be a sending time for an uplink channel or an uplink signal, such as a sending time for a Physical Random Access Channel (PRACH) triggered by a Physical Downlink Control Channel (PDCCH) order or higher layer, or for another example, a feedback time for performing Hybrid Automatic Repeat Request Acknowledgement (HARQ-ACK) on the PDCCH, and the PDCCH does not schedule the PDSCH, for example, the PDCCH carries Semi-Persistent Scheduling (SPS) release information.

The downlink transmission time may be a reception time for a downlink channel or a downlink signal, for example, a reception time for the PDCCH or the PDSCH.

The expected transmission time may be a transmission time expected by the UE, for example, when there is a resource conflict or a Hybrid automatic repeat request (HARQ) process ID conflict between a downlink dynamically scheduled PDSCH and a downlink Semi-Persistent Scheduling PDSCH (SPS PDSCH), and the UE preferentially receives the dynamically scheduled PDSCH, a time at which the UE expects to receive the PDCCH that dynamically schedules the PDSCH.

In this implementation, at least one of the transmission time interval, the transmission timing adjustment time, the switch time, the uplink transmission time, the downlink transmission time, and the expected transmission time can be relaxed, so that the UE can have more time to complete transmission, timing adjustment time and switching, so as to improve the communications performance of the UE.

It should be noted that in this embodiment of this application, the target time can include other times besides at least one mentioned above, for example, the target time can also include at least one of the following:
a time for applying an uplink timing advance order;
a resource overriding time of PUCCH (PUCCH resource overriding time) carrying the HARQ-ACK; and
a time for canceling the uplink transmission.

In some implementation, the transmission time interval includes:
a first minimum time between the last symbol of a PDCCH reception and the first symbol of PRACH transmission.

The first minimum time between the last symbol of the PDCCH reception and the first symbol of PRACH transmission may be a minimum time between the last symbol for the UE to receive a PDCCH order and the first symbol of PRACH transmission. This can relax the minimum time, and thus improve the transmission performance of PRACH.

For example, in an embodiment, for the UE (such as RedCap UE supporting the relaxed processing time), if random access is initiated by a PDCCH order, or an upper layer on a UE side requires the UE to transmit the PRACH in a selected PRACH occasion, the time between the last symbol of PDCCH order reception and the first symbol of PRACH transmission is greater than or equal to the first minimum time, where the first minimum time may include:

$${N}_{T , 2} + {Δ}_{BWPSwitching} + {Δ}_{Delay} + {T}_{switch}$$

N_{T,2} is a time length of N₂ symbols, corresponding to the PUSCH preparation time of the relaxed processing capability (namely, a UE processing capability 3). In addition, it is assumed that μ corresponds to the smallest SCS configuration between a subcarrier spacing (Subcarrier Spacing, SCS) configuration of the PDCCH order and the SCS configuration of the corresponding PRACH transmission, where μ represents the SCS used in a relevant channel.

In some embodiments, the first minimum time may include:

$$2 * {N}_{T , 2} + {Δ}_{BWPSwitching} + {Δ}_{Delay} + {T}_{switch}$$

N_{T,2} is a time length of N₂ symbols, which corresponds to a PUSCH preparation time for a UE processing capability 1.

In some embodiments, the first minimum time may include:

$${N}_{T , 2} + delta + {Δ}_{BWPSwitching} + {Δ}_{Delay} + {T}_{switch}$$

N_{T,2} is a time length of N₂ symbols, which corresponds to a PUSCH preparation time for a UE processing capability 1, and delta is determined by a network side based on the UE capability configuration, or a value of delta is fixed in the protocol.

It should be noted that in the above formula, Δ_{BWPSwitching} represents a switch time of a Bandwidth Part (BWP), for example, if the activated Uplink (UL) BWP has not changed, Δ_{BWPSwitching}=0; Δ_{Delay} represents a delay time, for example: FR1Δ_{Delay}=0.5 ms, and FR2Δ_{Delay}=0.25 ms; T_{switch} represents a switch gap duration defined in the protocol; and at least one of Δ_{BWPSwitching}, Δ_{BWPSwitching}, and T_{switch} can be determined by using the relaxed processing capacity, or can be defined in the protocol.

In some implementations, the transmission time interval includes at least one of the following:
a first maximum time between the last symbol of a random access response (RAR) window and the PRACH transmission; and
a second maximum time between the last symbol of an RAR PDSCH reception and the PRACH transmission.

The first maximum time between the last symbol of the RAR window and the PRACH transmission may be a maximum time between the last symbol of the RAR window for the UE and PRACH transmission in a case of being requested by a higher layer; and the second maximum time between the last symbol of the RAR PDSCH reception and the PRACH transmission may be a maximum time between the last symbol for the UE to receive the RAR PDSCH and transmit the PRACH in a case of being requested by the higher layer. This relaxes the maximum time, and thus improve the transmission performance of PRACH.

For example, in an embodiment, for the UE (such as the RedCap UE supporting the relaxed processing time), if requested by the upper layer of the UE, the UE should send the PRACH no later than X milliseconds (msec) after the last symbol of the random access response window or the last symbol of the PDSCH reception, such as sending the PRACH no later than N_{T,1}+0.75 milliseconds, where X is determined by at least one of the following manners.
Manner 1: X=N_{T,1}+0.75, where N_{T,1} corresponds to a symbol time of the PDSCH processing time of the relaxed processing capacity (namely, the UE processing capability 3), such as the duration corresponding to N₁ symbols. It is assumed that μ corresponds to an SCS of a PDCCH carrying a Downlink Control Information (DCI) format 1_0, and when an additional PDSCH DM-RS is configured, a minimum SCS in the SCS of the corresponding PDSCH and the SCS of the corresponding PRACH is configured. For μ=0, the UE assumes N_{1.0}=Y (for example, Y=28, whose value is determined based on the UE processing capability 3). For PRACH transmission using 1.25 kHz or 5 kHz SCS, the UE determines the configuration of the assumed SCS μ=0, where μ=0 indicates that a value of μ is a subcarrier interval corresponding to 0, for example, μ=0 indicates that the SCS is 15 kHz.
Manner 2: X=2*N_{T,1}+0.75 or X=2*(N_{T,1}+0.75), where N_{T,1} corresponds to a symbol time of a PDSCH processing time of the UE processing capability 1 (UE processing capability 1).
Manner 3: X=N_{T,1}+0.75+delta, where N_{T,1} corresponds to the symbol time of the PDSCH processing time of the UE processing capability 1 (UE processing capability 1), and delta is determined by the network side based on the UE capability configuration, or a value of delta is fixed in the protocol.

In some implementations, the transmission time interval includes:
a second minimum time between the last symbol of a PDCCH for a format of second Downlink Control Information (DCI) and the first symbol of a first resource transmitted on a PUCCH, where the first resource transmitted on the PUCCH includes: a first resource transmitted on a first PUCCH carrying HARQ-ACK information or a first resource transmitted on a second PUCCH carrying the HARQ-ACK information, the first PUCCH corresponds to a PDSCH without a corresponding PDCCH, and the second PUCCH is a PUCCH indicated by a first DCI format.

The first DCI format and the second DCI format are two different DCI formats defined in the protocol. The second minimum time between the last symbol of the PDCCH of the second DCI format and the first symbol of the first resource transmitted on the PUCCH may be the minimum time between the last symbol of the PDCCH of the second DCI format and the first symbol of the first resource transmitted on the first PUCCH carrying the HARQ-ACK information, where the first PUCCH corresponds to the PDSCH without a corresponding PDCCH; or the minimum time between the last symbol of the PDCCH of the second DCI format and the first symbol of the first resource transmitted on the second PUCCH carrying the HARQ-ACK information and indicated by the first DCI format. For example, in a slot n, the UE determines that the HARQ-ACK information for the PDSCH reception (without a corresponding PDCCH) is used for the first resource transmitted on the PUCCH. In some embodiments, the first DCI format (indicating the first resource for PUCCH transmission with corresponding HARQ-ACK information) is detected in the first slot, the second DCI format (indicating the second resource for PUCCH transmission) is also detected at a time later than the first slot, and corresponding HARQ-ACK information of the second DCI format is also in the slot n, the minimum time between the last symbol of the PDCCH including the second DCI format and the first symbol of the first resource transmitted on the PUCCH is determined. This relaxes the minimum time, and thus improve the transmission performance of PUCCH.

For example, in a case that an actual reception time for the PDCCH of the second DCI format does not meet the second minimum time, the UE does not expect a PUCCH resource in a target slot to multiplex HARQ-ACK information corresponding to the second DCI format, and the target slot is a slot for the first resource.

The actual reception time for the PDCCH of the second DCI format does not meet the second minimum time may be that an interval between the last symbol of the PDCCH of the second DCI format received by the UE and the first symbol of the first resource transmitted on the PUCCH is less than or equal to the second minimum time.

In this implementation, because the actual reception time for the PDCCH of the second DCI format does not meet the second minimum time, the UE does not expect a PUCCH resource in a target slot to multiplex HARQ-ACK information corresponding to the second DCI format, so that the transmission performance of PUCCH can be improved.

For example, in an embodiment, if the UE determines the first resource transmitted on the PUCCH carrying the HARQ-ACK information in one slot, the first resource corresponds to only PDSCH reception without a corresponding PDCCH, or the first resource corresponds to a first resource that is transmitted on the PUCCH carrying the corresponding HARQ-ACK information and that is indicated by the first DCI format detected by the UE. In addition, at a later time relative to a time when the first DCI format is received, the UE also detects a second DCI format indicating a second resource transmitted on the PUCCH carrying the corresponding HARQ-ACK information. If the UE receives the PDCCH including the second DCI format not earlier than the N₃·(2048+144)·κ·2^{-μ}·T_{c} start time of the first symbol of the first resource used for PUCCH transmission in the slot, the UE does not expect to multiplex the HARQ-ACK information corresponding to the second DCI format in the PUCCH resource in the slot. μ represents the SCS used for the relevant channels, κ and Tc are constants defined in the protocol, and N₃ is determined by at least one of the following manners.
Manner 1: In a case that a processingType2Enabled (processingType2Enabled) parameter in PDSCH-ServingCellConfig enables a serving cell of the second DCI format, and HARQ-ACK information corresponding to all serving cells is multiplexed in the PUCCH in the same slot, if μ=0, N₃=3, if μ=1, N₃=4.5, and if μ=2, N₃=9. In other cases, if μ=0, N₃=16, if μ=1, N₃=20, if μ=2, N₃=34, and if μ=3, N₃=40. For example, the value of N; depends on the relaxed processing capability (UE processing capability 3), and the UE is configured with the relaxed processing capability (UE processing capability 3) and a UE processing capability 2 (UE processing capability 2).
Manner 2: In a case that a processingType3Enabled parameter in PDSCH-ServingCellConfig enables a serving cell of the second DCI format, and HARQ-ACK information corresponding to all serving cells is multiplexed in the PUCCH in the same slot, if μ=0, N₃=16, if μ=1, N₃=20, if N₃=2, N₃=34, and if μ=3, N₃=40. In other cases, if μ=0 N₃=8, if μ=1, N₃=10, if N₃=2, N₃=17, and if μ=3, N₃=20. For example, the value of N₃ depends on the relaxed processing capability (UE processing capability 3), and in this manner, the UE is configured with the UE processing capability 3 and the UE processing capability 1 (UE processing capability 1). The UE processing capability 3 can be configured by the network for using or not, and the UE processing capability 1 is a capability used by the UE by default, that is, if the network does not configure the UE processing capability 3 for the UE, the UE uses the UE processing capability 1 by default.
Manner 3: In a case that a processingType1Enabled parameter in PDSCH-ServingCellConfig enables a serving cell of the second DCI format, and HARQ-ACK information corresponding to all serving cells is multiplexed in the PUCCH in the same slot, if μ=0, N₃=8, if μ=1, N₃=10, if =2, N₃=17, and if μ=3, N₃=20. In other cases, if μ=0, N₃=16, if μ=1, N₃=20, if μ=2, N₃=34, and μ=3, N₃=40. For example, the value of N; depends on the relaxed processing capability (UE processing capability 3), and in this manner, the UE is configured with the relaxed processing capability (UE processing capability 3) and the UE processing capability 1 (UE processing capability 1). The UE processing capability 1 can be configured by the network for using or not, and the UE processing capability 3 is a capability used by the UE by default, that is, if the network does not configure the UE processing capability 1 for the UE, the UE uses the UE processing capability 3 by default.
Manner 4: In a case that a processingType2Enabled parameter in PDSCH-ServingCellConfig enables a serving cell of the second DCI format, and HARQ-ACK information corresponding to all serving cells is multiplexed in the PUCCH in the same slot, if μ=0 N₃=3 if N₃=1, N₃=4.5, and if N₃=2, N, =9; and in a case that a processing Type3Enabled, parameter in PDSCH-ServingCellConfig enables a serving cell of the second DCI format, and HARQ-ACK information corresponding to all serving cells is multiplexed in the PUCCH in the same slot, if μ=0, N₃=16, if μ=1, N₃=20, if μ=2, N₃=34, and if μ=3, N₃=40. In other cases, if μ=0 N₃=8 if μ=1 N₃=10, if =2, N₃=17, and if μ=3 N₃=20
Manner 5: In a case that a processingType2Enabled parameter in PDSCH-ServingCellConfig enables a serving cell of the second DCI format, and HARQ-ACK information corresponding to all serving cells is multiplexed in the PUCCH in the same slot, if μ=0 N₃=3 if N₃=1, N₃=4.5, and if N₃=2, N; =9; and in a case that a processingType1Enabled parameter in PDSCH-ServingCellConfig enables a serving cell of the second DCI format, and HARQ-ACK information corresponding to all serving cells is multiplexed in the PUCCH in the same slot, if μ=0, N₃=8, if μ=1, N₃=10, if μ=2, N, =17, and if μ=3, N₃=20. In other cases, if μ=0, N₃=16, if μ=1, N₃=20, if μ=2, N₃=34, and if μ=3, N₃=40.

It should be noted that μ=0, μ=1, μ=2, and μ=3 respectively represent subcarrier intervals corresponding to values of μ: 0, 1, 2, and 3 in the table defined in the protocol.

In some embodiments, the transmission time interval includes:
a transmission time interval between a transmission time of HARQ-ACK information that is in response to SPS PDSCH releasing and the last symbol of the PDCCH used for SPS PDSCH releasing.

The transmission time interval between the transmission time of the HARQ-ACK information that is in response to SPS PDSCH releasing and the last symbol of the PDCCH used for SPS PDSCH releasing can be that the network expects the UE to send the HARQ-ACK information that is in response to SPS PDSCH releasing after providing N symbols of the last symbol of the PDCCH used for SPS PDSCH releasing, where N symbols are the transmission time interval, and the value of N is determined based on the relaxed processing capacity. This relaxes the transmission time interval, and thus improve the transmission performance for the HARQ-ACK information.

For example, in an embodiment, the UE provides the HARQ-ACK information in response to SPS PDSCH releasing after providing N symbols of the last symbol of the PDCCH used for SPS PDSCH releasing. The value of N is from at least one of the following manners.
Manner 1: If processingType2Enabled of PDSCH-ServingCellConfig is set to be enabled, for a serving cell with the PDCCH providing SPS PDSCH releasing, when μ=0, N=5; when μ=1, N=5.5; and when μ=2, N=1.
Manner 2: If processingType1Enabled of PDSCH-ServingCellConfig is set to be enabled, for a serving cell with the PDCCH providing SPS PDSCH releasing, when μ=0, N=10; when μ=1, N=12; when μ=2, N=22, and when μ=3, N=25. Otherwise, when μ=0, N=20; when μ=1, N=24; when μ=2, N=44; and when μ=3, N=50, where μ corresponds to the smallest SCS configuration between the SCS configuration of the PDCCH providing SPS PDSCH releasing and the SCS configuration of the PUCCH that carries the HARQ-ACK information in response to SPS PDSCH releasing.
Manner 3: If processingType3Enabled of PDSCH-ServingCellConfig is set to be enabled, for a serving cell with the PDCCH providing SPS PDSCH releasing, when μ=0, N=20; when μ=1, N=24; when μ=2, N=44, and when μ=3, N=50. Otherwise, when μ=0, N=10; when μ=1, N=12; when μ=2, N=22; and when μ=3, N=25, where μ corresponds to the smallest SCS configuration between the SCS configuration of the PDCCH providing SPS PDSCH releasing and the SCS configuration of the PUCCH that carries the HARQ-ACK information in response to SPS PDSCH releasing.

In some embodiments, the transmission time interval includes:
a third minimum time between the last symbol of a PDCCH that dynamically schedules a PDSCH and a start symbol of the SPS PDSCH.

The third minimum time between the last symbol of the PDCCH that dynamically schedules the PDSCH and the start symbol of the SPS PDSCH may be the minimum time N between the last symbol for the UE to receive the PDCCH that dynamically schedules the PDSCH and the start symbol of SPS PDSCH, where N is determined based on the relaxed processing capacity. This relaxes the minimum time, and thus improve the receiving performance of PDSCH.

For example, the third minimum time is determined based on the relaxed processing capacity in a case that the UE has a conflict, and the UE preferentially receives a dynamically scheduled PDSCH; and
the conflict includes at least one of the following:
a resource conflict between the dynamically scheduled PDSCH and the SPS PDSCH; and
an HARQ process ID (HARQ Process ID) conflict between the dynamically scheduled PDSCH and the SPS PDSCH.

In this implementation, when there is a resource conflict or a HARQ process ID conflict between the downlink dynamically scheduled PDSCH and the downlink SPS PDSCH, and the UE preferentially receives the dynamically scheduled PDSCH, the minimum time N between the last symbol for the UE to receive the PDCCH that dynamically schedules the PDSCH and the start symbol of the SPS PDSCH can be defined based on the relaxed processing capacity. In the case of the above conflict, the minimum time is relaxed, and the receiving performance of PDSCH is improved.

For example, in an embodiment, if a dynamic PDSCH scheduled by the PDCCH and one or more PDSCHs without being scheduled by a corresponding PDCCH partially or completely overlap in time in the same serving cell, the UE does not expect to decode the PDSCH scheduled by the PDCCH and scrambled by a Cell Radio Network Temporary Identifier (C-RNTI), a Configured Scheduling Radio Network Temporary Identifier (CS-RNTI), or a Modulation and Coding Scheme Cell-Radio Network Temporary Identifier (MCS-C-RNTI), unless the PDCCH scheduling the PDSCH ends in a case of at least N₁ symbols before the earliest start symbol of the semi-persistent PDSCH without being scheduled by a corresponding PDCCH. The symbol duration is the minimum SCS between the SCS of a scheduling PDCCH and the SCS of the PDSCH. In this case, the UE decodes the PDSCH scheduled by the PDCCH. The value of N₁ is from at least one of the following manners.
Manner 1: being fixed to X symbols in the protocol, where X=14 or 28.
Manner 2: the value of N₁ is determined based on the UE processing capacity currently configured by the UE in the serving cell.
Manner 3: the value of N₁ is twice that of the UE processing capability 1 (UE processing capability 1) or the UE processing capability 2 (UE processing capability 2).
Manner 4: The value of N₁ is UE processing capability 1+delta or UE processing capability 2+delta or 14+delta, where delta is reported by the UE capability and determined based on the network configuration, or the value of delta is fixed in the protocol.

In some embodiments, the transmission time interval includes:
a target time interval between a start symbol of a retransmitted PDSCH and the last symbol of a PDSCH earlier than the retransmitted PDSCH.

The PDSCH earlier than the retransmitted PDSCH may be the latest PDSCH among PDSCHs earlier than the retransmitted PDSCH.

The target time interval between the start symbol of the retransmitted PDSCH and the last symbol of the PDSCH earlier than the retransmitted PDSCH may be, in a given scheduling cell, if a time between the start symbol of a retransmitted PDSCH and the last symbol of a PDSCH earlier than the retransmitted PDSCH is less than N symbols for any PDSCH corresponding to a System Information RNTI (SI-RNTI), the value of N is determined based on the relaxed processing capacity. This relaxes the target time interval, and thus improve the receiving performance of PDSCH.

For example, the UE does not expect to decode the retransmitted PDSCH in a case that the time interval between the start symbol of the actual transmission time for the retransmitted PDSCH and the last symbol of the PDSCH earlier than the retransmitted PDSCH is less than the target time interval.

In this implementation, in a case that the actual transmission time of the retransmitted PDSCH does not meet the target time interval, because the UE does not expect to decode the retransmitted PDSCH, the UE may not decode the retransmitted PDSCH when the target time interval is not met, so as to reduce the workload of the UE and improve the communications performance of the UE. For example, in a given scheduling cell, for any PDSCH corresponding to the SI-RNTI, if a time between the start symbol of a retransmitted PDSCH and the last symbol of a PDSCH earlier than the retransmitted PDSCH is less than N symbols, the target UE does not expect to decode retransmission of the PDSCH.

For example, in an embodiment, in a given scheduled cell, for any PDSCH corresponding to the SI-RNTI, the UE does not expect to decode retransmission of an earlier transmitted PDSCH, and a start symbol thereof is less than N symbols after the last symbol of the earlier transmitted PDSCH, where the value of N depends on the configuration of PDSCH subcarrier interval μ, and N is determined by one of the following manners.
Manner 1: when μ=0, N=13; when μ=1, N=20; and when μ=3, N=24.
Manner 2: if the target UE supports and/or is configured to enable the UE processing capability 3, when μ=0, N=26; when μ=1, N=40; and when μ=3, N=48. Otherwise, when μ=0, N=13; when μ=1, N=20; and when μ=3, N=24.

In some embodiments, the expected transmission time includes:
a target time period after the last symbol of a COontrol REsource SET (CORESET) in a preset DCI format received by the UE, where the UE does not expect to cancel PUSCH transmission or Sounding Reference Signal (SRS) transmission before an uplink symbol within the target time period.

The preset DCI format can be a DCI format defined in the protocol, for example, a DCI format 2_4. For example, at the minimum time T after the UE receives the last symbol of the CORESET of the DCI format 2_4, the UE does not expect to cancel PUSCH transmission or SRS transmission before the uplink symbol corresponding to the time T.

In this implementation, because the target time period is relaxed, the transmission performance of PUSCH and SRS can be improved.

For example, in an embodiment, the UE does not expect to cancel PUSCH transmission or SRS transmission before the UE detects a symbol occupied by T_{proc,2} after the last symbol of the CORESET of the DCI format 2_4. The value of T_{proc,2} is from at least one of the following manners.
Manner 1: being fixed to Y symbols in the protocol.
Manner 2: the value of T_{proc,2} is determined based on the UE processing capacity, and the UE processing capacity is at least one of the following:
UE processing capability 1;
UE processing capability 2; and
UE processing capability 3.
Manner 3: the value of T_{proc,2} is twice that of the UE processing capability 1 or the UE processing capability 2.
Manner 4: the value of T_{proc,2} is the value of the UE processing capability 1 or 2+delta, where delta is determined by the network based on the UE capacity configuration, or the value of delta is fixed in the protocol.

In some embodiments, the transmission timing adjustment time includes:
a slot n+k+1, where the UE receives a timing advance order in a receiving slot n and adjusts uplink transmission timing in the slot n+k+1, and n and k are positive integers.

In this implementation, the UE can receive a timing advance order from an uplink slot n (uplink slot n) and adjust the uplink transmission timing in a slot n+k+1 (slot n+k+1), where slot n+k+1 is determined based on the relaxed processing capacity. In this way, the time for adjusting the uplink transmission timing can be relaxed, so that the UE can have more time to respond to the timing advance order, thereby improving the communications performance of the UE.

For example, in an embodiment, if the UE receives the timing advance order in the uplink slot n, an uplink transmission time sequence is correspondingly adjusted from an uplink slot n+k+1 except for uplink transmission of the PUSCH scheduled by RAR UL grant or fallbackRAR

UL grant, or uplink transmission in which the PUCCH with the HARQ-ACK information is fed back to success random access response (successRAR). k is determined by at least one of the following manners.

$$k = ⌈ {N}_{slot}^{subframe , μ} \cdot ( {N}_{T , 1} + {N}_{T , 2} + {N}_{TA , max} + 0.5 ) / {T}_{sf} ⌉ \qquad Manner 1$$

N_{T,1} is a processing time of N₁ symbols corresponding to the relaxed processing capability (UE processing capability 3) used by the target UE for a PDSCH with additional DMRS; N_{T,2} is a preparation time of N₂ symbols corresponding to the relaxed processing capability (UE processing capability 3) used by the target UE for a PUSCH; and N_{TA,max} is the maximum timing advance value (in milliseconds) that can be provided by 12-bit Timing Advance (TA) order field, Nₛₗₒₜ^{subframe} is the number of slots for per subframe, and T_{sf} is subframe duration of 1 millisecond.

$$k = ⌈ {N}_{slot}^{subframe , μ} \cdot ( 2 \cdot {N}_{T , 1} + 2 \cdot {N}_{T , 2} + {N}_{TA , max} + 0.5 ) / {T}_{sf} ⌉ , \qquad Manner 2$$

$$k = 2 \cdot ⌈ {N}_{slot}^{subframe , μ} \cdot ( {N}_{T , 1} + {N}_{T , 2} + {N}_{TA , max} + 0.5 ) / {T}_{sf} ⌉ , or$$

$$k = ⌈ 2 \cdot {N}_{slot}^{subframe , μ} \cdot ( {N}_{T , 1} + {N}_{T , 2} + {N}_{TA , max} + 0.5 ) / {T}_{sf} ⌉ ,$$

N_{T,1} is a processing time for the target UE to use N/symbols corresponding to the UE processing capability 1 for the PDSCH configured with additional DMRS; and N_{T,2} is a preparation time for the target UE to use N₂ symbols corresponding to the UE processing capability 1 for the PUSCH.

$$k = ⌈ {N}_{slot}^{subframe , μ} \cdot ( {N}_{T , 1} + {N}_{T , 2} + delta + {N}_{TA , max} + 0.5 ) / {T}_{sf} ⌉ , \qquad Manner 3$$

N_{T,1} is a processing time for the target UE to use N₁ symbols corresponding to the UE processing capability 1 for the PDSCH configured with additional DMRS; and N_{T,2} is a preparation time for the target UE to use N₂ symbols corresponding to the UE processing capability 1 for the PUSCH, where delta is determined by the network based on the UE capacity configuration, or the value of delta is fixed in the protocol.

In some embodiments, the switch time may include at least one of the following:
a search space set switch time; and
a Bandwidth Part (BWP) switch time.

In this implementation, relaxed search space set switch time and BWP switch time can be implemented, so that the switching performance of the UE can be improved.

For example, in an embodiment, the UE can provide P_{switch} symbols by using a searchSpaceSwitchDelay parameter, and if the target UE supports or is configured with the processing capability 3, a corresponding minimum value of P_{switch} is determined by at least one of the following manners.
Manner 1: N times the corresponding value of the UE processing capability 1 or the UE processing capability 2 (see Table 1 below), where n is a positive integer greater than or equal to 1.
Manner 2: the corresponding value of the UE processing capability 1 or the UE processing capability 2 (see Table 2 below)+delta, where delta is determined by the network based on the UE capacity configuration, or the value of delta is fixed in the protocol.
Manner 3: being determined by the UE processing capacity 3 in Table 2 below.

TABLE 1

| | Minimum P_{switch} | Minimum P_{switch} |
|---|---|---|
| | value for | value for |
| | UE processing | UE processing |
| | capability 1 | capability 2 |
| μ | [symbols] | [symbols] |
| 0 | 25 | 10 |
| 1 | 25 | 12 |
| 2 | 25 | 22 |

TABLE 2

| | Minimum P_{switch} | Minimum P_{switch} | Minimum P_{switch} |
|---|---|---|---|
| | value for | value for | value for |
| | UE processing | UE processing | UE processing |
| | capability 1 | capability 2 | capability 3 |
| μ | [symbols] | [symbols] | [symbols] |
| 0 | 25 | 10 | 36 |
| 1 | 25 | 12 | 40 |
| 2 | 25 | 22 | 50 |

μ represents SCS of a channel, Minimum P_{switch} value for UE processing capability 1 [symbols] represents the minimum value of P_{switch} corresponding to the UE processing capability 1, UE processing capability 2 [symbols] represents the minimum value of P_{switch} corresponding to the UE processing capability 2, and UE processing capability 3 [symbols] represents the minimum value of P_{switch} corresponding to the UE processing capability 3.

For example, in an embodiment, if the UE supports and/or is configured to enable the UE processing capability 3, the UE should complete BWP switching within a period of Y. Y is determined by at least one of the following manners.
Manner 1: Y=T_{BWPswitchDelay} of type 2 in Table 3.
Manner 2: Y=n times of T_{BWPswitchDelay} of type 2 or T_{BWPswitchDelay} of type 1 shown in Table 3, where n is a positive integer greater than or equal to 1.
Manner 3: Y=T_{BWPswitchDelay} of type 2 or T_{BWPswitchDelay}+delta of type 1, as shown in Table 3, where delta is determined by the network based on the UE capacity configuration, or the value of delta is fixed in the protocol.
Manner 4: Y is equal to T_{BWPswitchDelay} of type 3 in Table 4 below.

TABLE 3

| | | BWP switch delay | |
|---|---|---|---|
| | NR slot | T_{BWPswitchDelay} (slots) | |
| μ | length (ms) | Type 1 | Type 2 |
| 0 | 1 | 1 | 3 |
| 1 | 0.5 | 2 | 5 |
| 2 | 0.25 | 3 | 9 |
| 3 | 0.125 | 6 | 18 |

Type 1: Depend on a slot length of UE capability
Type 2: If BWP switch involves changing SCS, the BWP switch delay is determined based on the smaller SCS between SCS before BWP switch and SCS after BWP switch

TABLE 4

| | | BWP switch delay | | |
|---|---|---|---|---|
| | NR slot | T_{BWPswitchDelay} (slots) | | |
| μ | length (ms) | Type 1 | Type 2 | Type 3 |
| 0 | 1 | 1 | 3 | 6 |
| 1 | 0.5 | 2 | 5 | 10 |
| 2 | 0.25 | 3 | 9 | 20 |
| 3 | 0.125 | 6 | 18 | 40 |

Type 1, Type 3: Depend on a slot length of UE capability
Type 2: If BWP switch involves changing SCS, the BWP switch delay is determined based on the smaller SCS between SCS before BWP switch and SCS after BWP switch

In some embodiments, the method further includes:
in a case that a transmission time of a PDSCH scheduled by a Radio Network Temporary Identifier (RNTI) is determined based on the relaxed processing capacity, decoding, by the UE, the PDSCH scheduled by the first RNTI and a PDSCH scheduled by a second RNTI, where
in a case that the transmission time of the PDSCH scheduled by the first Radio Network Temporary Identifier (RNTI) is determined based on a first processing capacity or a second processing capacity, the UE does not decode the PDSCH scheduled by the first RNTI, or the UE determines that the first RNTI scheduling the PDSCH is an incorrect schedule, where
a processing time for the relaxed processing capacity is longer than a processing time for the first processing capacity, and the processing time for the relaxed processing capacity is longer than a processing time for the second processing capacity.

The first RNTI may include at least one of the following:
C-RNTI, MCS-C-RNTI, and CS-RNTI; and
the second RNTI may include SI-RNTI.

In this implementation, in cells with frequency range FR1 and/or FR2, in the process of obtaining System Information (SI) triggered by a Paging-Radio Network Temporary Identifier (P-RNTI), if the PDSCH scheduled by C-RNTI, MCS-C-RNTI, or CS-RNTI is determined based on the relaxed processing capacity, the UE can decode the first PDSCH scheduled by C-RNTI, MCS-C-RNTI, or CS-RNTI and the second PDSCH scheduled by SI-RNTI, and resources of the first PDSCH and the second PDSCH do not overlap in frequency domain but partially or completely overlap in time domain. Otherwise, the UE performs at least one of the following operations:
if the PDSCH scheduled by C-RNTI, MCS-C-RNTI, or CS-RNTI uses the UE processing capability 1 (UE processing capability 1) or the UE processing capability 2 (UE processing capability 2), the UE does not decode the PDSCH scheduled by C-RNTI, MCS-C-RNTI, or CS-RNTI; and
being determined as incorrect scheduling, that is, the UE does not expect overlapping of time domain resources to occur (which should be avoided in the network side).

In this implementation, the PDSCH scheduled by the first RNTI and the PDSCH scheduled by the second RNTI can be accurately decoded through the relaxed processing capability, so as to improve the performance of the UE in decoding the PDSCH.

In some embodiments, in a case that the UE has been configured with or has enabled the relaxed processing capability, the UE does not expect to be configured with at least one of the following:
a DCI format 2_4; and
multiplexing among uplink channels of the UE in different priorities (ul-IntraUE-Mux).

In this implementation, the UE does not expect to be configured with at least one item mentioned above, which indicates that if the at least one item is configured, the UE considers it as an incorrect configuration or does not respond to the configuration. In this way, the conflict between the relaxed processing capability and the configuration can be avoided due to the UE not expecting at least one of the above items, so as to avoid the occurrence of incorrect communications operations.

In this embodiment of this application, in a case that UE has been configured with or has enabled a relaxed processing capability, a target time related to communication is determined based on the relaxed processing capability, where the relaxed processing capability refers to a processing capability that is relaxed in time. In this way, the target time related to communication is determined based on the relaxed processing capability, and thus the communication-related time of the UE can be relaxed, to improve the communications performance of the UE.

The method for determining a processing time provided in this embodiment of this application may be executed by an apparatus for determining a processing time. In this embodiment of this application, that the apparatus for determining a processing time performs the method for determining a processing time is used as an example to describe the method for determining a processing time provided in the embodiments of this application.

Referring to FIG. 3, FIG. 3 is a structural diagram of an apparatus for determining a processing time according to an embodiment of this application. As shown in FIG. 3, the apparatus includes:
a determining module 301, configured to: in a case that UE has been configured with or has enabled a relaxed processing capability, determine, based on the relaxed processing capability, a target time related to communication, where the relaxed processing capability refers to a processing capability that is relaxed in time.

For example, the target time related to communication includes at least one of the following:
a transmission time interval, a transmission timing adjustment time, a switch time, an uplink transmission time, a downlink transmission time, and an expected transmission time.

For example, the transmission time interval includes at least one of the following:
a first minimum time between the last symbol of a PDCCH reception and the first symbol of PRACH transmission;
a first maximum time between the last symbol of a RAR window and the PRACH transmission;
a second maximum time between the last symbol of an RAR PDSCH reception and the PRACH transmission;
a second minimum time between the last symbol of a PDCCH for a format of second DCI and the first symbol of a first resource transmitted on a PUCCH, where the first resource transmitted on the PUCCH includes: a first resource transmitted on a first PUCCH carrying HARQ-ACK information or a first resource transmitted on a second PUCCH carrying the HARQ-ACK information, the first PUCCH corresponds to a PDSCH without a corresponding PDCCH, and the second PUCCH is a PUCCH indicated by a first DCI format;
a transmission time interval between a transmission time of HARQ-ACK information that is in response to semi-persistent scheduling (SPS) PDSCH releasing and the last symbol of the PDCCH used for SPS PDSCH releasing;
a third minimum time between the last symbol of a PDCCH that dynamically schedules a PDSCH and a start symbol of the SPS PDSCH; and
a target time interval between a start symbol of a retransmitted PDSCH and the last symbol of a PDSCH earlier than the retransmitted PDSCH.

For example, in a case that an actual reception time for the PDCCH of the second DCI format does not meet the second minimum time, the UE does not expect a PUCCH resource in a target slot to multiplex HARQ-ACK information corresponding to the second DCI format, and the target slot is a slot for the first resource.

For example, the third minimum time is determined based on the relaxed processing capacity in a case that the UE has a conflict, and the UE preferentially receives a dynamically scheduled PDSCH; and
the conflict includes at least one of the following:
a resource conflict between the dynamically scheduled PDSCH and the SPS PDSCH; and
an HARQ process ID conflict between the dynamically scheduled PDSCH and the SPS PDSCH.

For example, the UE does not expect to decode the retransmitted PDSCH in a case that the time interval between the start symbol of the actual transmission time for the retransmitted PDSCH and the last symbol of the PDSCH earlier than the retransmitted PDSCH is less than the target time interval.

For example, the expected transmission time includes:
a target time period after the last symbol of a control resource set in a preset DCI format received by the UE, where the UE does not expect to cancel PUSCH transmission or sounding reference signal (SRS) transmission before an uplink symbol within the target time period.

For example, the switch time includes at least one of the following:
a search space set switch time; and
a BWP switch time.

For example, the transmission timing adjustment time includes:
a slot n+k+1, where the UE receives a timing advance order in a receiving slot n and adjusts uplink transmission timing in the slot n+k+1, and n and k are positive integers.

For example, the apparatus further includes:
a decoding module, configured to: in a case that a transmission time of a PDSCH scheduled by a first RNTI is determined based on the relaxed processing capacity, decode the PDSCH scheduled by the first RNTI and a PDSCH scheduled by a second RNTI, where
in a case that the transmission time of the PDSCH scheduled by the first RNTI is determined based on a first processing capacity or a second processing capacity, the UE does not decode the PDSCH scheduled by the first RNTI, or the UE determines that the first RNTI scheduling the PDSCH is an incorrect schedule, where
a processing time for the relaxed processing capacity is longer than a processing time for the first processing capacity, and the processing time for the relaxed processing capacity is longer than a processing time for the second processing capacity.

For example, the first RNTI includes at least one of the following:
a C-RNTI, a MCS-C-RNTI, and a CS-RNTI; and
the second RNTI includes a SI-RNTI.

For example, in a case that the UE has been configured with or has enabled the relaxed processing capability, the UE does not expect to be configured with at least one of the following:
a DCI format 2_4; and
multiplexing among uplink channels of the UE in different priorities.

For example, the apparatus further includes:
an execution module, configured to perform corresponding communications operations based on the target time.

The apparatus for determining a processing time can improve the communications performance of the UE.

The apparatus for determining a processing time in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the types of the terminal listed in the embodiments of this application. The another device may be a server, a Network Attached Storage (NAS), and the like. This is not specifically limited in this embodiment of this application.

The apparatus for determining a processing time provided in this embodiment of this application can implement the processes implemented in the method embodiment shown in FIG. 2, and achieve a same technical effect. To avoid repetition, details are not provided herein again.

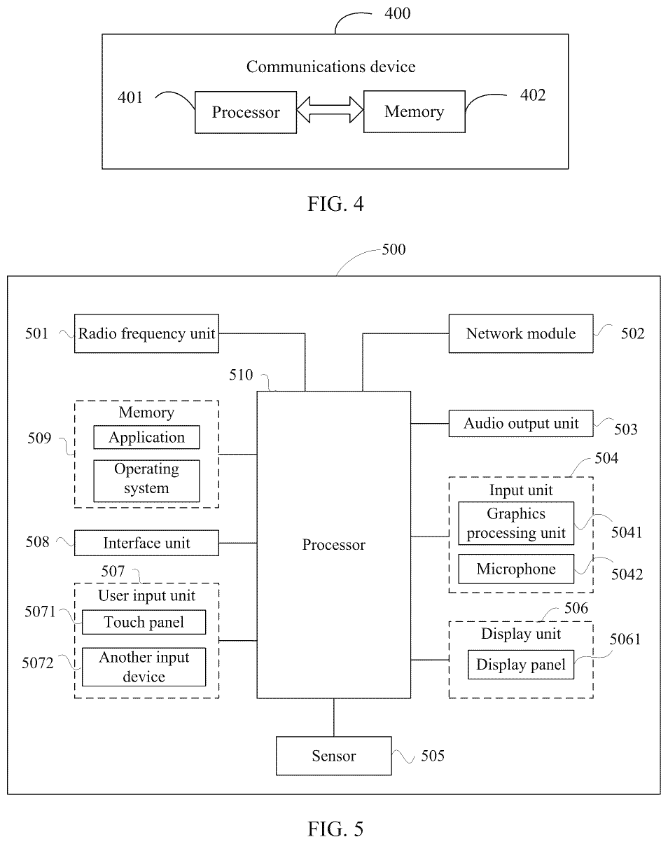

For example, as shown in FIG. 4, an embodiment of this application further provides a communications device 400, including a processor 401 and a memory 402. The memory 402 stores a program or an instruction that can be run on the processor 401. For example, when the communications device 400 is a terminal, the program or the instruction is executed by the processor 401 to implement steps of the embodiment of the method for determining a processing time, and a same technical effect can be achieved.

An embodiment of this application further provides a terminal, including a processor and a communications interface, where the processor or the communications interface is configured to: in a case that UE has been configured with or has enabled a relaxed processing capability, determine, based on the relaxed processing capability, a target time related to communication, where the relaxed processing capability refers to a processing capability that is relaxed in time. The terminal embodiment is corresponding to the terminal side method embodiment, each implementation process and implementation of the method embodiment can be applied to the terminal embodiment, and a same technical effect can be achieved. Specifically, FIG. 5 is a schematic diagram of a hardware structure of a terminal according to an embodiment of this application.

A terminal 500 includes but is not limited to at least a part of components such as a radio frequency unit 501, a network module 502, an audio output unit 503, an input unit 504, a sensor 505, a display unit 506, a user input unit 507, an interface unit 508, a memory 509, and a processor 510.

A person skilled in the art can understand that the terminal 500 may further include a power supply (such as a battery) that supplies power to each component. The power supply may be logically connected to the processor 510 by using a power supply management system, to implement functions such as charging and discharging management, and power consumption management by using the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a Graphics Processing Unit (GPU) 5041 and a microphone 5042. The graphics processing unit 5041 processes image data of a static picture or a video obtained by an image capture apparatus (for example, a camera) in a video capture mode or an image capture mode. The display unit 506 may include a display panel 5061, and the display panel 5061 may be configured in a form of a liquid crystal display, an organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 501 may transmit the downlink data to the processor 510 for processing. In addition, the radio frequency unit 501 may send uplink data to the network side device. Generally, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or an instruction and a second storage area for storing data. The first storage area may store an operating system, and an application or an instruction required by at least one function (for example, a sound playing function or an image playing function). In addition, the memory 509 may be a volatile memory or a non-volatile memory, or the memory 509 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 509 in this embodiment of this application includes but is not limited to these memories and any memory of another proper type.

The processor 510 may include one or more processing units. For example, an application processor and a modem processor are integrated into the processor 510. The application processor mainly processes an operating system, a user interface, an application, or the like. The modem processor mainly processes a wireless communication signal, for example, a baseband processor. It may be understood that, in some embodiments, the modem processor may not be integrated into the processor 510.

The radio frequency unit 501 or the processor 510 is configured to: in a case that UE has been configured with or has enabled a relaxed processing capability, determine, based on the relaxed processing capability, a target time related to communication, where the relaxed processing capability refers to a processing capability that is relaxed in time.

For example, the target time related to communication includes at least one of the following:
a transmission time interval, a transmission timing adjustment time, a switch time, an uplink transmission time, a downlink transmission time, and an expected transmission time.

For example, the transmission time interval includes at least one of the following:
a first minimum time between the last symbol of a PDCCH reception and the first PRACH transmission;
a first maximum time between the last symbol of a RAR window and the PRACH transmission;
a second maximum time between the last symbol of an RAR PDSCH reception and the PRACH transmission;
a second minimum time between the last symbol of a PDCCH for a format of second DCI and the first symbol of a first resource transmitted on a PUCCH, where the first resource transmitted on the PUCCH includes: a first resource transmitted on a first PUCCH carrying HARQ-ACK information or a first resource transmitted on a second PUCCH carrying the HARQ-ACK information, the first PUCCH corresponds to a PDSCH without a corresponding PDCCH, and the second PUCCH is a PUCCH indicated by a first DCI format;
a transmission time interval between a transmission time of HARQ-ACK information that is in response to SPS PDSCH releasing and the last symbol of the PDCCH used for SPS PDSCH releasing;
a third minimum time between the last symbol of a PDCCH that dynamically schedules a PDSCH and a start symbol of the SPS PDSCH; and
a target time interval between a start symbol of a retransmitted PDSCH and the last symbol of a PDSCH earlier than the retransmitted PDSCH.

For example, in a case that an actual reception time for the PDCCH of the second DCI format does not meet the second minimum time, the UE does not expect a PUCCH resource in a target slot to multiplex HARQ-ACK information corresponding to the second DCI format, and the target slot is a slot for the first resource.

For example, the third minimum time is determined based on the relaxed processing capacity in a case that the UE has a conflict, and the UE preferentially receives a dynamically scheduled PDSCH; and
the conflict includes at least one of the following:
a resource conflict between the dynamically scheduled PDSCH and the SPS PDSCH; and
an HARQ process ID conflict between the dynamically scheduled PDSCH and the SPS PDSCH.

For example, the UE does not expect to decode the retransmitted PDSCH in a case that the time interval between the start symbol of the actual transmission time for the retransmitted PDSCH and the last symbol of the PDSCH earlier than the retransmitted PDSCH is less than the target time interval.

For example, the expected transmission time includes:
a target time period after the last symbol of a control resource set in a preset DCI format received by the UE, where the UE does not expect to cancel PUSCH transmission or SRS transmission before an uplink symbol within the target time period.

For example, the switch time includes at least one of the following:
a search space set switch time; and
a BWP switch time.

For example, the transmission timing adjustment time includes:
a slot n+k+1, where the UE receives a timing advance order in a receiving slot n and adjusts uplink transmission timing in the slot n+k+1, and n and k are positive integers.

For example, the radio frequency unit 501 or the processor 510 is further configured to:
in a case that a transmission time of a PDSCH scheduled by a first RNTI is determined based on the relaxed processing capacity, decode the PDSCH scheduled by the first RNTI and a PDSCH scheduled by a second RNTI, where
in a case that the transmission time of the PDSCH scheduled by the first RNTI is determined based on a first processing capacity or a second processing capacity, the UE does not decode the PDSCH scheduled by the first RNTI, or the UE determines that the first RNTI scheduling the PDSCH is an incorrect schedule, where
a processing time for the relaxed processing capacity is longer than a processing time for the first processing capacity, and the processing time for the relaxed processing capacity is longer than a processing time for the second processing capacity.

For example, the first RNTI includes at least one of the following:
a C-RNTI, a modulation and coding MCS-C-RNTI, and a CS-RNTI; and
the second RNTI includes a SI-RNTI.

For example, in a case that the UE has been configured with or has enabled the relaxed processing capability, the UE does not expect to be configured with at least one of the following:
a DCI format 2_4; and
multiplexing among uplink channels of the UE in different priorities.

The UE can improve the communications performance of the UE.

An embodiment of this application further provides a readable storage medium, where the readable storage medium stores a program or an instruction, and when the program or the instruction is executed by a processor, the processes of the embodiment of the method for determining a processing time are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communications interface, and the communications interface is coupled to the processor. The processor is configured to run a program or an instruction, to implement the processes of the embodiment of the method for determining a processing time, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program product. The computer program product is stored in a storage medium, and the computer program product is executed by at least one processor to implement the processes of the embodiment of the method for determining a processing time, and a same technical effect can be achieved. To avoid repetition, details are not described herein again.

An embodiment of this application further provides a transmission determining system, including a terminal and a network side device, where the terminal may be configured to perform steps of the method for determining a processing time as described above.

An embodiment of this application further provides a communications device, configured to perform the processes of the embodiment of the method for determining a processing time, and a same technical effect is achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. I Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for determining a processing time, comprising:
when UE has been configured with or has enabled a relaxed processing capability, determining, based on the relaxed processing capability, a target time related to communication, wherein the relaxed processing capability is a processing capability that is relaxed in time.

2. The method according to claim 1, wherein the target time related to communication comprises at least one of the following:
a transmission time interval, a transmission timing adjustment time, a switch time, an uplink transmission time, a downlink transmission time, and an expected transmission time.

3. The method according to claim 2, wherein the transmission time interval comprises at least one of the following:
a first maximum time between a last symbol of a Random Access Response (RAR) window and a Physical Random Access Channel (PRACH) transmission; or
a second maximum time between receiving a last symbol of an RAR in a Physical Downlink Shared Channel (PDSCH) and the PRACH transmission.

4. The method according to claim 3, wherein the UE send the PRACH no later than X milliseconds after the last symbol of the RAR window or the last symbol received in the PDSCH when required by an upper layer of the UE, wherein
X=N_{T,1}+0.75+delta,
where N_{T,1} corresponds to a symbol time of the PDSCH processing time of a UE processing capability, and delta is determined by a network side based on a UE capability configuration, or a value of the delta is fixed in a protocol.

5. The method according to claim 3, wherein when an actual reception time of a second Downlink Control Information (DCI) format for the PDCCH does not meet a second minimum time between the a symbol of the second DCI format in a PDCCH and a first symbol of a first resource transmitted on the PUCCH, a PUCCH resource in a target slot to is not be multiplexed with a Hybrid Automatic Repeat Request Acknowledgement (HARQ-ACK) information corresponding to the second DCI format by the UE, and the target slot is a slot for the first resource.

6. The method according to claim 3, wherein a third minimum time is determined based on the relaxed processing capacity when the UE has a conflict, and the UE preferentially receives a dynamically scheduled PDSCH; and
the conflict comprises at least one of the following:
a resource conflict between the dynamically scheduled PDSCH and a Semi-Persistent Scheduling (SPS) PDSCH; or
a Hybrid Automatic Repeat Request (HARQ) process ID conflict between the dynamically scheduled PDSCH and the SPS PDSCH.

7. The method according to claim 3, wherein a retransmitted PDSCH is not decoded by the UE when a time interval between a start symbol of an actual transmission time for the retransmitted PDSCH and a last symbol of a PDSCH earlier than the retransmitted PDSCH is less than a target time interval between the start symbol of the retransmitted PDSCH and the last symbol of the PDSCH earlier than the retransmitted PDSCH.

8. The method according to claim 2, wherein the expected transmission time comprises:
a target time period after a last symbol of a control resource set in a preset DCI format received by the UE, wherein a Physical Uplink Shared Channel (PUSCH) transmission or a sounding reference signal (SRS) transmission is not canceled by the UE before an uplink symbol within the target time period.

9. The method according to claim 2, wherein the switch time comprises at least one of the following:
a search space set switch time; or
a bandwidth part (BWP) switch time.

10. The method according to claim 2, wherein the transmission timing adjustment time comprises:
a slot n+k+1, wherein the UE receives a timing advance order in a receiving slot n and adjusts an uplink transmission timing in the slot n+k+1, where n and k are positive integers.

11. The method according to claim 1, wherein the method further comprises:
when a transmission time of a PDSCH scheduled by a first radio network temporary identifier (RNTI) is determined based on the relaxed processing capacity, decoding, by the UE, the PDSCH scheduled by the first Radio Network Temporary Identifier (RNTI) and a PDSCH scheduled by a second RNTI, wherein
when the transmission time of the PDSCH scheduled by the first RNTI is determined based on a first processing capacity or a second processing capacity, the UE does not decode the PDSCH scheduled by the first RNTI, or the UE determines that the PDSCH scheduled by the first RNTI is an incorrect schedule, wherein
a processing time for the relaxed processing capacity is longer than a processing time for the first processing capacity, and the processing time for the relaxed processing capacity is longer than a processing time for the second processing capacity.

12. The method according to claim 11, wherein the first RNTI comprises at least one of the following:
a Cell Radio Network Temporary Identifier (C-RNTI), a Modulation and Coding Scheme Cell-Radio Network Temporary Identifier (MCS-C-RNTI), or a Configured Scheduling Radio Network Temporary Identifier (CS-RNTI); and
the second RNTI comprises a System Information Radio Network Temporary Identifier (SI-RNTI).

13. A UE, comprising:
a memory storing computer-readable instructions; and
a processor coupled to the memory, wherein the instructions, when executed by the processor, cause the processor to perform operations comprising:
determining, based on a relaxed processing capability, a target time related to communication when that the UE has been configured with or has enabled the relaxed processing capability, wherein the relaxed processing capability is a processing capability that is relaxed in time.

14. The UE according to claim 13, wherein the target time related to communication comprises at least one of the following:
a transmission time interval, a transmission timing adjustment time, a switch time, an uplink transmission time, a downlink transmission time, or an expected transmission time.

15. The UE according to claim 14, wherein the transmission time interval comprises at least one of the following:
a first maximum time between a last symbol of a RAR window and a transmission of a PRACH transmission; or
a second maximum time between receiving a last symbol of an RAR in a PDSCH and the PRACH transmission.

16. A UE according to claim 16, wherein the instructions, when executed by the processor, cause the processor to further perform:
sending the PRACH no later than X milliseconds after the last symbol of the RAR window or the last symbol received in the PDSCH when required by an upper layer of the UE, wherein
X=N_{T,1}+0.75+delta,
where N_{T,1} corresponds to a symbol time of the PDSCH processing time of a UE processing capability, and delta is determined by a network side based on a UE capability configuration, or a value of the delta is fixed in a protocol.

17. A non-transitory computer readable storage medium storing instructions, when executed by a processor, cause the processor to perform operations comprising:
determining, based on a relaxed processing capability, a target time related to communication when a UE has been configured with or has enabled the relaxed processing capability, wherein the relaxed processing capability is a processing capability that is relaxed in time.

18. The non-transitory computer readable storage medium according to claim 17, wherein the target time related to communication comprises at least one of the following:
a transmission time interval, a transmission timing adjustment time, a switch time, an uplink transmission time, a downlink transmission time, and an expected transmission time.

19. The non-transitory computer readable storage medium according to claim 18, wherein the transmission time interval comprises at least one of the following:
a first maximum time between a last symbol of a RAR window and a of a PRACH transmission; or
a second maximum time between receiving a last symbol of an RAR in a PDSCH and the PRACH transmission.

20. The non-transitory computer readable storage medium according to claim 19, wherein the instructions, when executed by the processor, cause the processor to further perform:
sending the PRACH no later than X milliseconds after the last symbol of the RAR window or the last symbol received in the PDSCH when required by an upper layer of the UE, wherein
X=N_{T,1}+0.75+delta,
where N_{T,1} corresponds to a symbol time of a PDSCH processing time of a UE processing capability, and delta is determined by a network side based on a UE capability configuration, or a value of the delta is fixed in a protocol.
